(19) United States
(12) Patent Application Publication
(10) Pub. No.: US 2009/0220651 A1
(43) Pub. Date: Sep. 3, 2009

(54) METHODS FOR CHARACTERIZING FOODS AND DRINKS

(76) Inventors: Robert E. Buxton, Nashville, TN (US); Daniel J. Simpson, Nashville, TN (US)

Correspondence Address: O'Connor & Company, P.O. Box 7389, Broomfield, CO, 80021-0024, US

(21) Appl. No.: 12/390,401

(22) Filed: Feb. 20, 2009

Related U.S. Application Data
(60) Provisional application No. 61/032,260, filed on Feb. 28, 2008.

(51) Int. Cl. A23P 1/00; G09F 3/00

(52) U.S. Cl. 426/87; 426/383

(57) ABSTRACT

This invention relates to the labeling of wine for descriptive, educational, and informational purposes. Specifically, in preferred embodiments, labels are provided that display graphically the multifactorial components of taste intensity, taste location on the palate, and tasting descriptors, optionally with supplementary information (type of grape, region where wine is produced, smell of the wine, etc). The methods described herein are further extended to a wide variety of foods and drinks.

### PRIORITY DATA

This patent application claims priority under 35 U.S.C. §120 from U.S. Provisional Patent Application No. 61/032,260, filed Feb. 28, 2008, which is hereby incorporated herein by reference for all purposes.

### FIELD OF THE INVENTION

The present invention relates generally to the characterization of flavor profiles of foods and drinks, such as (but not limited to) wine.

### BACKGROUND OF THE INVENTION

Consumers generally rely on labels when making consumer decisions. Labels can inform consumers about the contents of items being purchased, including foods and drinks. However, certain foods and drinks have complex flavor profiles and a wide variety of parameters that can affect taste. Information provided on labels often is insufficient to characterize these foods and drinks.

A good example is wine. Information on wine labels, if provided at all, usually provides only subjective and frequently abstract written descriptions of the characteristics of the wine. Occasionally, additional information is provided regarding the technique used in making the wine, proper serving temperature for the wine, and guidance on the types of food the wine will best accompany.

For the average consumer, buying wine is an arduous task. Little information is provided on the bottle or displayed in the store describing the characteristics of the wine. The average consumer has no tools for making an accurate assessment of the actual taste of the wine (Lockshin and Hall, “Consumer Purchasing Behaviour for Wine: What We Know and Where We are Going,” Proceedings of the International Colloquium in Wine Marketing, 2003). The large variety of wines in a single wine store only exacerbates the problem.

Similarly, restaurants often give little information about the actual taste of wines on their wine lists, thereby requiring patrons to spend a significant amount of money on little more than a guess. Market-research studies have shown that consumers are often confused and intimidated by the vast selection of wines along with their lack of knowledge of wine and wine attributes. To aid the wine selection process, some consumers rely on objective factors to categorize wine. For example, wine may be classified based on grape variety or variety blend (e.g., Cabernet Sauvignon, Merlot, Syrah, etc.), growing region or appellation (e.g., Napa Valley, Bordeaux, etc.), vintage (e.g., 1999) or brand (e.g., Clos du Bois Cabernet Sauvignon). Although these categories provide a way to describe wine, these objective factors are not reliable predictors of wine flavor, and provide little guidance and education for comparing flavor differences between wines.

To overcome the static nature of such classification systems, several wine experts and wine magazines have developed systems for categorizing wine based on other criteria. For example, some wine critics, such as Robert Parker and Stephen Tanzer, have developed ratings scales to classify wine. The ratings scales typically use a 100-point scale to rate wine quality. Each wine is assigned a score or a score range (e.g., 90-100) on the scale based on any of a variety of factors, such as color, appearance, aroma, and finish. These qualitative ratings are essentially intended to classify a wine as either good or bad. Although such ratings can communicate information regarding overall wine quality, the ratings are of little help in categorizing wine in terms of actual flavors that are experienced by a consumer.

Wines can be tasted by a professional who then proffers a wine rating (usually between 1 and 100) and writes a brief description called a tasting note. While popular, this method of rating wines has inherent limitations because the rating of any wine requires that a wine taster make a qualitative judgment on the characteristics and attributes of the wine. However, each individual's palate is unique which makes any rating of quality subjective and extremely limited to that person's frame of reference. Subjective interpretations of wine characteristics are generally too abstract and sophisticated for the average inexperienced consumer.

Some market research has concluded that there is an underutilization of the back label of wine bottles where descriptive information about the wine is most likely to appear (Halstead, “How Do Consumers Select Wine? Factors that Affect the Purchase Decision Making Process in the Wine Category,” Annual Academy of Marketing in Nottingham, 2002).

In view of the foregoing limitations, it would be desirable to provide methods for characterizing wine in a way that is simple and easy to understand for the average consumer, while at the same time providing a useful characterization of the actual flavors associated with the wine. Additionally, there are many other foods and drinks, beyond wine, that could commercially benefit from a new characterization approach.

### SUMMARY OF THE INVENTION

The present invention addresses the aforementioned commercial needs in the art.

In some variations, the invention provides a method of characterizing a food, the method comprising:

(a) identifying a plurality of food characteristics each including a taste descriptor, an intensity descriptor, and a palate location;

(b) forming a label that includes each of the plurality of food characteristics; and

(c) associating the label to the food.

In some embodiments, the plurality of food characteristics is three or more characteristics each including a taste descriptor, an intensity descriptor, and a palate location.

Some methods further include identifying one or more smell factors each including an aroma descriptor and an intensity level.

In preferred embodiments, the label includes a graph that is suitable for illustrating the taste descriptor, the intensity descriptor, and the palate location for at least some of the characteristics identified in step (a) above. In some embodiments, the graph is suitable for illustrating the taste descriptor, the intensity descriptor, and the palate location for each of the characteristics identified in step (a).

Some labels of the invention further include supplemental information that is not substantially included in the graph.

In some embodiments, the label is a physical label that is directly coupled to a container comprising the food. In other embodiments, the label is a physical label that is not directly coupled to a container comprising the food.

The invention can also be practiced or realized electronically. In some embodiments, the label is constructed from digital information, and the label is communicated over a network (such as the Internet or a local area network).

In some embodiments of the invention, the food is selected from the group consisting of wine, beer, coffee, tea, chocolate, cheese, and tobacco (such as cigars).

Certain variations of the invention provide a method of characterizing wine, the method comprising:

(a) identifying three or more wine characteristics each including a taste descriptor, an intensity descriptor, and a palate location;

(b) forming a label that includes each of the wine characteristics; and

(c) associating the label to the wine.

In some embodiments for wine, the method further comprises identifying a smell factor including an aroma descriptor and an intensity level.

Preferably, the label includes a graph that is suitable for illustrating the taste descriptor, the intensity descriptor, and the palate location for each of the wine characteristics identified in step (a) for these certain methods of characterizing wine.

Optionally, the label further includes supplemental wine information that is not substantially included in the graph. The label can be directly coupled to a bottle of the wine by adhesion and/or the use of a bottle neck tag, or by other known means.

The present invention also relates to labels. In some variations, a label for characterizing a food (such as wine) comprises means for displaying a plurality of food characteristics each including a taste descriptor, an intensity descriptor, and a palate location. The label can further include means for displaying one or more smell factors each including an aroma descriptor and an intensity level.

In a specific embodiment, a wine label includes a graph that is suitable for illustrating the taste descriptor, the intensity descriptor, and the palate location for each of the characteristics. The graph includes a first axis for displaying the intensity descriptor and a second axis for displaying the palate location. The label optionally includes supplemental wine information that is not substantially included in the graph. The label is coupled to a bottle of the wine by adhesion and/or the use of a bottle neck tag.

### BRIEF DESCRIPTION OF THE DRAWINGS

FIG. 1 is an exemplary label provided by the present invention for wine, in some embodiments.

FIG. 2 is another exemplary label provided by the present invention for wine, in some embodiments.

FIG. 3 is an exemplary label provided by the present invention for beer, in some embodiments.

FIG. 4 is an exemplary label provided by the present invention for coffee, in some embodiments.

FIG. 5 is an exemplary label provided by the present invention for tea, in some embodiments.

FIG. 6 is an exemplary label provided by the present invention for cheese, in some embodiments.

FIG. 7 is an exemplary label provided by the present invention for chocolate, in some embodiments.

FIG. 8 is an exemplary label provided by the present invention for olive oil, in some embodiments.

FIG. 9 is an exemplary label provided by the present invention for cigars, in some embodiments.

### DETAILED DESCRIPTION OF EMBODIMENTS OF THE INVENTION

The methods and systems of the present invention will now be described in detail by reference to various non-limiting embodiments of the invention.

Unless otherwise indicated, all numbers used in the specification and claims are to be understood as being modified in all instances by the term “about.” Without limiting the application of the doctrine of equivalents to the scope of the claims, each numerical parameter should at least be construed in light of the number of reported significant digits and by applying ordinary rounding techniques.

One variation of the present invention provides for characterization of wine. This detailed description, for illustration purposes, will emphasize the characterization of wine, followed by a discussion and examples for characterization of many other foods, drinks, and other consumables. In some variations, this invention relates to the labeling of wine for descriptive, educational, and informational purposes. Nevertheless, it is expressly intended that this invention is not limited to wine. Many variations, embodiments, and advantages will become apparent from the following description and accompanying drawings.

Informational and educational wine labels can be provided by this invention to inform consumers of the characteristics and attributes of the wine. In some embodiments, a graph is included on the left side of the label and a supplemental information section is included on the right side of the label. The graph can have two or more distinct palate locations shown on the X-axis of the graph. The Y-axis can show the taste intensity of the particular wine, such as subtle, medium, or full-bodied; or subtle vs. intense. Other taste descriptors or flavors may also be included to describe the wine. Preferred labels contribute to a tasting experience, providing consumers with an overall visual picture of the characteristics and attributes of the wine prior to a purchase.

In some variations, this invention provides a method of characterizing wine, the method comprising:

(a) identifying a plurality of wine characteristics each including a taste descriptor, an intensity descriptor, and a palate location;

(b) forming a label that includes each of the plurality of wine characteristics; and

(c) associating the label to the wine.

A “plurality” as used herein means two or more. In some embodiments, three or more characteristics are identified, each including a taste descriptor, an intensity descriptor, and a palate location.

“Palate location,” as used in this specification, is intended to refer to perceived sensual tastes experienced at different stages (in time) as a food or drink enters the mouth, moves around inside the mouth, and is swallowed. Palate location is sometimes also used to refer to physical location within the mouth of a person. While the meaning intended herein primarily relates to location in time, not in space, it will be recognized by a skilled artisan that there can be a space/time correlation during food or drink consumption. It is believed that a typical consumer is better able to identify tastes experienced temporally, starting from the time the food or drink (e.g., wine) enters the mouth to the time the food or drink is swallowed, along with any aftertastes.

The first taste, or impression, of the wine when it lands in the mouth of a person is known as “front” (also known as upfront, forward, entry, or attack). The specific timing associated with this initial taste can be about 1-10 seconds after the wine first enters the mouth, such as about 3-6 seconds. The exact timing is not critical, as it will be expected to vary with the amount of liquid in the first entry as well as the front intensity. An intensity is identified in conjunction with the front taste. The intensity can be described in many ways. When the intensity is rather weak, for instance, exemplary descriptions include subtle, delicate, slight, restrained, fine, or understated. When the intensity is rather strong, one can simply use “intense” but other possible terms include e.g. strong, robust, powerful, deep, extreme, severe, and so on.

The next palate location can be characterized as “middle,” the taste experienced as the wine is held in the mouth. Middle is also known as mid-palate, or even simply palate. In this middle palate location, the consumer may swirl, bite, chew, and/or move the wine around in the mouth, then let it settle. Such actions are known in the art as “aerating” the wine. This middle palate location occurs after the front stage, although there can be some overlap as will be appreciated. Typically, middle begins about 6-20 seconds after the first wine entry into the mouth, such as about 10-15 seconds. The middle phase can consume varying amounts of time, depending on how long the consumer or taster wishes to hold the wine. An intensity is also identified in conjunction with the middle taste.

The “finish” palate location is the taste experienced at the point of and/or just after swallowing. Finish is also known as aftertaste or length. Consumers (or professional tasters) can choose to stay in the middle stage for shorter or longer periods of time, thereby delaying finish, depending on preference. Typically, however, finish begins about 10 seconds to about 1 minute after first wine entry into the mouth, such as about 15-30 seconds. For more-complex flavor profiles, longer times to finish can be beneficial, to experience the complexity. The length of time for the finish palate location will vary; it is conventional wisdom that the longer the finish (e.g., lingering flavors), the better the wine. A corresponding intensity is also identified in conjunction with the finish taste.

In some embodiments, the method further includes identifying one or more olfaction factors (“smell” or “aroma” factors as used herein). Olfaction refers to the sense of smell. Olfaction, along with taste, is a form of chemoreception. The human nose can distinguish among hundreds of substances, even in minute quantities. Smell and taste together contribute to perceived flavor, so it can be important—although not necessary—to characterize the (preferably initial) aroma of wine as part of an overall description. In preferred methods and labels, smell factors each include an aroma descriptor and an intensity level. The intensity level for aroma can be, for example, described as “subtle” or “intense.” The aroma factor can be characterized as “nose” in some labels of the invention.

In preferred embodiments of the invention, the label includes a graph that is suitable for visually illustrating the taste descriptor, the intensity descriptor, and the palate location for at least some, and preferably all, of the taste characteristics identified. Graphs can provide an effective multifactorial representation of wine. Many variations of graphs are possible.

For example, taste intensity levels can be plotted or depicted in the Y-axis of the graph, with the intensity level descriptors (e.g., subtle and intense) shown along the left or right side of the graph, preferably with indications of a more-intense taste being higher on the Y-axis (semi-quantitative). The intensity can be delineated into two, three, or more descriptions. While these descriptions are qualitative in nature, it would also be possible to ascribe a fully quantitative attribute if desired, such as a number on some selected numerical scale.

On the X-axis of preferred graphs, palate location is depicted, optionally along with an aroma or smell factor. It is desirable, chronologically, to display the palate locations from time zero (initial wine entry into mouth) to the time of swallowing, moving from left to right on the X-axis. Thus, the axis would include front, middle, and then finish on the far right. Although this manner of plotting would be conventional, some other way to depict palate locations on the X-axis (or another axis) would also fall within the scope of variations contemplated by this invention. It would also be possible to quantify the palate location by using a time dimension on the X-axis, such as number of seconds elapsed since initial wine entry. This embodiment would tend to be more difficult to test and understand for the average consumer; also, there will be variations in the specific times associated with each palate location for different individuals, as recited above. Therefore, qualitative/semi-quantitative descriptions on the X-axis are preferred.

Preferred graphs comprising an X-axis and a Y-axis further include taste descriptors placed within the XY-space. The text of the taste descriptors can be accompanied by dots, circles, ovals, squares, or some other shape. The text (e.g., “dark cherry”) can be within such shape, or can be written outside of the shape. Also, text can be used without any other shape, in which case the text should be in the appropriate XY-position, for clarity. The locations of these taste descriptors can be called “tasting points.” In some embodiments, the tasting points are connected by lines (solid, dashed, or otherwise). Reference is made to the graphs shown in the Examples herein below.

There are many additional notes and supplemental information that can be further included in labels provided by this invention, as will be appreciated. The type of wine is preferably included. Wine types include red, white, sparkling, rose, port, sherry, and so on. The style of wine is also preferably identified on the label. Exemplary styles include dry, semi-dry, semi-sweet, and sweet. Also, the body can be included. “Body” describes how thick (e.g., oily) or thin (e.g., watery) a wine feels to a person. Body is also sometimes referred to as “mouth feel” and can also be described as light, medium, or heavy. For example, light body can be described as feeling in the mouth like skim milk, whereas medium and full body can feel like 2% milk and whole milk, respectively.

Supplemental information could further include (but is by no means limited to) any or all of the following details:
(1) Name of the wine
(2) Grapes used in the wine
(3) Region in which grapes were grown
(4) How the wine smells after being poured into a glass
(5) Color of the wine (or other factors associated with sight)
(6) Date the wine was tasted
(7) How long the wine was decanted (time wine was exposed to oxygen after opening but before wine is consumed)
(8) Year the wine was made (vintage)
(9) Wine rating
(10) Image or description to illustrate the balance of the wine, balance being how the five elements of sweetness, acidity, alcohol, tannins, and flavor are integrated
(11) Chemical properties of the wine, such as alcohol content, sugar content, acid content, phenol content, pH, viscosity, density, and other properties
(12) Recommended glass for wine

In some embodiments, additional information can be gathered for the purpose of supplementary notes. For example, chemical analysis of the wine could be carried out to determine one or more properties of the wine, e.g. to check for air intrusion (which would tend to cause certain chemical reactions leading to reduced quality). Exemplary chemical analysis for wine is described in U.S. Pat. No. 5,200,909 to Juergens.

In particular embodiments, a wine label is provided, wherein the label comprises a graph that is suitable for illustrating the taste descriptor, intensity descriptor, and palate location for each of three or more taste characteristics, wherein the graph includes a first axis for displaying the intensity descriptor and a second axis for displaying the palate location. This label can further include supplemental wine information that is not substantially included in the graph. Optionally, the label further includes supplemental wine information that is not substantially included in the graph.

Variations of the invention provide for use of the labels, described herein, in methods of marketing, distributing, and/or selling wine. These labels can offer consumers ample information to provide maximum enjoyment while simultaneously educating the consumer about his or her preferences. A user of these labels can feel confident about his or her knowledge of the product and increase satisfaction by having better knowledge of the product itself.

Wine becomes a commodity for wineries once the grapes are harvested, the fermenting and aging process is completed, and the finished product is placed in a bottle or other container. The winery then usually applies a label to the exterior of the bottle containing information about the attributes of the wine and the winery.

Wineries have a variety of channels by which to distribute their product to consumers. One method is to sell the wine directly to consumers who visit their respective winery. Another method is to sell their wines via a web site or printed material and ship their wines to customers in states that allow such transactions.

Another method of selling their wine involves partnering with alcohol distributors in each state to distribute their wines to retailers, restaurants, bars, and other establishments.

The methods and labels of the invention may be utilized by any of the entities described above, including a winery, distributor, wine store, restaurant, and so on. The invention could also be used by a third party such as a salesman, agent, or other entity in the business of promoting wines.

The parties may begin by evaluating different types of wines sold by one of the entities described above. Both parties can engage in a process of selecting a wine, having professionals taste the wine, constructing an agreed-upon descriptive label for the wine, and then applying the label to one or more objects related to the wine. Objects related to the wine include not only wine bottles, boxes, and cases but also restaurant menus, wine lists, brochures, shelf talkers, shelf takers, and neck tags.

A “shelf talker” is an object, usually made from paper or plastic, which is fixed in place to display information for a consumer at the point of sale. Shelf talkers are common in stores for selling wine. The label of the invention can be attached to the shelf talker by a variety of methods, such as direct ink printing, or by affixing the label using an adhesive, staples, or other known means.

A “shelf taker” is an object, usually made from paper, which can be taken away by a consumer at the point of sale. Usually a store would provide a plurality of shelf takers in a stack, box, or other device that allows for consumers to remove one shelf taker at a time. Common examples of shelf takers include coupons provided at the point of sale. When shelf takers are used in methods of the present invention, labels can be included by a variety of methods, preferably by direct ink printing.

A “neck tag” is a removable tag, usually made from paper or plastic, with a hole in one end that can be slipped over the neck of a bottle so that the tag can hang from the wine bottle. The label of the invention can be attached to the next tag by a variety of methods, such as direct ink printing, or by affixing the label using an adhesive, staples, or other known means.

The descriptive label of the invention described herein may be produced by a method comprising a collaborative process between (i) an entity such as a winery, distributor, wine store, or restaurant, and (ii) the user of the invention. Or any of these entities may practice the invention themselves.

First, the relevant entity needs to evaluate different wines. One approach is to have professionals taste the wine. Then, the relevant entity builds or constructs a descriptive label for the wine, gets approval from the involved parties regarding the descriptive label, and applies the label to the product or to objects related to the product such as a restaurant wine list, shelf talker, or neck tag.

Typically, wineries produce a number of different varietals and/or blends each year (vintage). The collaborative process can begin when the involved parties select a particular wine to be labeled. Some parties involved in building a label for the winery might include the wine maker(s), the owner(s) of the winery, operational management, and/or sales and marketing.

In some embodiments, a wine promoter may proceed to taste the same vintage and varietal of wine tasted by the winery. This tasting could involve a wine-tasting panel led by a wine director who is a professional in the wine industry, called a “sommelier.” The purpose of the wine-tasting panel is to maintain the integrity of the descriptive label so that it does not become simply a marketing tool but rather a unique product separate from the wine and that its content contain objective information that wine consumers can trust. For example, the wine panel may taste the wine and agree that there is a strawberry flavor upfront and concur that it is of medium intensity but might add an additional flavor of red currant to the taste descriptor and the upfront taste location.

A wine promoter could then present the findings to the winery, receive feedback and substantial agreement is preferably reached as to the exact flavor description that would appear on the label. This process with the winery would be repeated for each section within the label.

Once the winery and wine promoter agree on a completed label and the winery agrees to use the label on its product, the winery can decide whether it wants to use a label that is independent of (not incorporated into) a previously established and existing label. Optionally, the winery may choose to incorporate the descriptive label into its existing and established label.

Labels are then produced by a label manufacturer and affixed to the wine bottles. Labels can be applied to bottles in several ways. If the winery is relatively small, a mobile unit can be dispatched to the winery and the labels applied on-site using known industry labeling equipment. If the winery is relatively large, there are free-standing facilities that service the wine industry, wherein bottles are labeled off-site and then transported to the individual winery. In either scenario, the descriptive label can be applied using industry labeling equipment and methods, as will be known to a person skilled in the consumer-products labeling art.

In some embodiments, the winery can also be supplied with additional descriptive label products. These products preferably contain a label similar, or identical, to the label placed on the bottles. These products include shelf talkers that are placed on the shelf of a wine retailer to offer the consumer information about the wine prior to purchase. Another product is a neck tag. The descriptive label is placed on, or printed onto, the neck tag, as described above.

If the collaborative process for building a descriptive label is between a wine retailer and a wine promoter, the process could consist of a wine-tasting panel using their collective professional judgment and methods to build a label in accordance with the methods provided herein. In some embodiments, a wine retailer would have little or no input into the label creation, as the retailer may not include professionals in the wine industry beyond owning a business that sells wine. Descriptive labels can be manufactured and placed on bottles by hand or by handheld labeling devices, given the relatively small number of bottles in the inventory of a wine retailer.

If the collaborative process for building a descriptive label is between a restaurant and a wine promoter, there may be collaboration in building the graphs as many high-end restaurants have a sommelier on staff. Both parties could taste as many or as few wines as the restaurant desired. Either or both parties could utilize the methods taught herein. The restaurant may enlist the sommelier on staff, the chef, the restaurant owner(s), and other invested parties to taste the wine. When multiple parties characterize a wine, a final label is preferably approved by both parties. The descriptive label can then be incorporated into the restaurant's wine list.

If a collaborative process exists between a wine distributor and a wine promoter, the wine distributor might not participate in the building of a label unless a sommelier is on staff at the distributor, or unless a wine professional is hired. The process would be similar to that described above, whereby the wine-tasting panel would create a label to be printed at a label manufacturer. Those labels could then be applied to the bottles at the distributor's facility. The distributor could also be given other products such as shelf takers, shelf talkers, or neck tags.

Generally, the tasting points for labels of the invention can be determined by any human. The invention is not limited to tasting by any particular class of experts. Tasting can be done by an employee or owner of a winery, a professional, a sommelier, an agent, or a consumer, followed by creation of at least one label of the invention.

In general, the labels of the invention can be either physical or virtual (electronic). Physical labels can be either directly coupled to a container (e.g., by an adhesive onto a bottle) comprising a food or drink, such as wine, or alternatively can be indirectly associated to the container by a variety of means (e.g., a bottle neck tag). It is, of course, preferable for a label to be sized appropriately for the size of the bottle or container. One exemplary size of labels is 1.5 in.×3 in., but the invention is not limited to any particular label dimensions. Labels can be black and white, grayscale, or constructed using one or a variety of colors. Label colors can be selected for marketing or aesthetics reasons, for example.

In some embodiments, the label (a “virtual label”) is constructed from digital information received over a computer network, and then the label is associated to the wine by communication over a network. For example, an Internet site could be provided for the purpose of label creation, i.e. entry of the necessary data to build a graph for a particular wine. A server could be configured to receive the data and electronically generate graphs. The digital data could then be provided to a label manufacturer for physical label creation, or to a client or affiliate for posting on another web site. Also, such virtual labels constructed digitally could be sent by electronic mail, instant message, and the like. Of course, virtual labels can be printed and used as described herein.

In some embodiments, a consumer could go to an Internet site to view a label for a particular wine. Or a store could provide a computer or kiosk with an Internet connection, or with memory suitable for storing digital data associated with the label, for consumers to view prior to (or after) purchase. These virtual labels could be provided in addition to, or instead of, physical labels associated with bottles of wine.

In some embodiments, an Internet site is established and used for the purpose of providing a portal wherein a plurality of wine professionals and sommeliers can carry out methods of this invention, to create virtual labels. These labels can then be marketed, sold, and/or distributed to wine stores, restaurants, and the like by either electronic means or physical means, as described herein above.

Variations of the present invention are contemplated for any food, drink, or consumable having non-trivial flavor profiles. For the purposes of defining the scope of the invention claimed, “food” is intended to include any substance that can be eaten, drunk, or otherwise consumed by a human for nutrition or pleasure. Foods can include processed, partially processed, and unprocessed materials. Items that are only partly consumed, but for which certain flavors can be extracted, are included (e.g., chewing gums). Also, tobacco and tobacco products are included in this definition of food.

The methods and labels of the invention are particularly suitable for wine, beer, coffee, tea, chocolate, cheese, and cigars. Many other foods for which consumers could benefit from characterization in accordance with this invention include, but are by no means limited to, sparkling wine (e.g., champagne), whiskey, brandy (e.g., cognac), wine coolers, and other alcoholic beverages; sodas, flavored waters, energy drinks, fruit drinks (e.g., grape juice), and other non-alcoholic beverages; sauces; soups; smoked meats (e.g., beef jerky); salty snacks; nuts; cereals; dairy products; oils; and natural or artificial sweeteners.

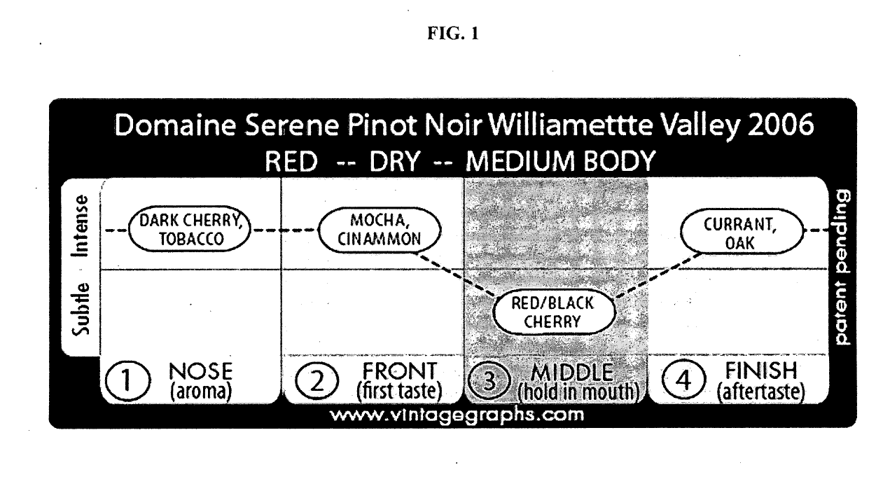

Various non-limiting labels provided by this invention are shown in FIGS. 1-9 which are described further below in the Examples.

### EXAMPLE 1

FIG. 1 is an exemplary label comprising a graph, for wine. In FIG. 1, the Y-axis includes two intensity descriptors (subtle and intense) while the X-axis includes nose (aroma) plus three palate locations (front, middle, and finish). There are four tasting points represented by ovals containing text descriptions. For example, the tasting point for front (first taste) is “mocha, cinnamon” and is in the upper half of the Y-axis, denoting an intense flavor.

### EXAMPLE 2

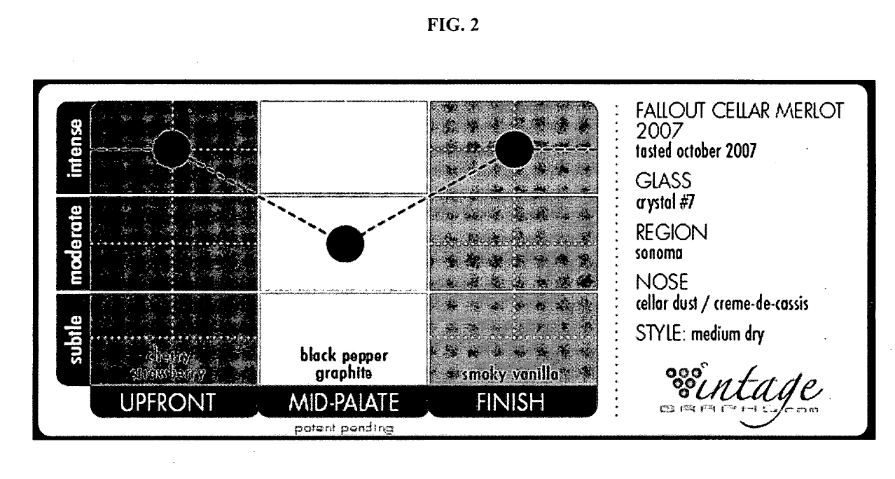

FIG. 2 is another exemplary label comprising a graph, for wine. In FIG. 2, the Y-axis includes three intensity descriptors (subtle, moderate, and intense) while the X-axis includes three palate locations. No aroma/smell characteristic is included in this embodiment. Here, there are three tasting points represented by solid black circles, with the associated text not within such circles but rather near the bottom of the plot, just above the X-axis. The graph in FIG. 2 is further accompanied by supplementary notes as depicted therein.

### EXAMPLE 3

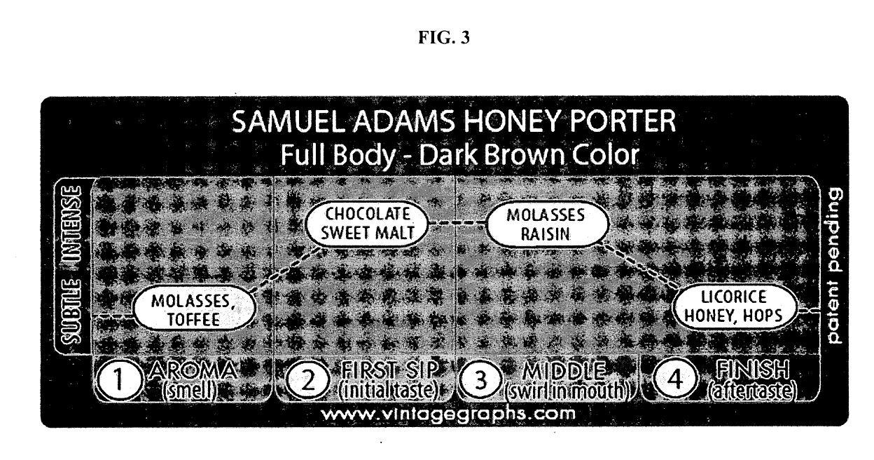

FIG. 3 is an exemplary label comprising a graph, for beer. In FIG. 3, the Y-axis includes two intensity descriptors (subtle and intense) while the X-axis includes smell (aroma) plus three palate locations (first sip, middle, and finish). There are four tasting points represented by ovals containing text descriptions. For example, the tasting point for first sip is “molasses, toffee” and is in the lower half of the Y-axis, denoting a subtle flavor.

### EXAMPLE 4

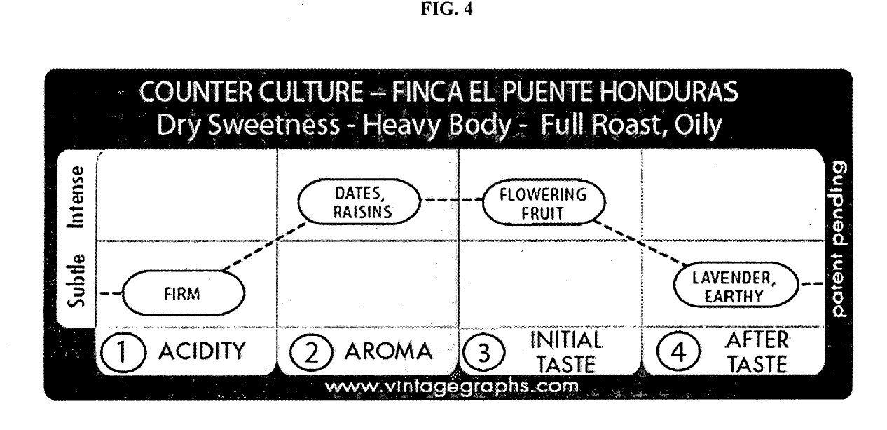

FIG. 4 is an exemplary label comprising a graph, for coffee. In FIG. 4, the Y-axis includes two intensity descriptors (subtle and intense) while the X-axis includes acidity, aroma, and two palate locations (initial taste and aftertaste). It is noted that acidity could also be thought of as a palate location, but acidity tends to be a continuous effect rather than temporal or fleeting. There are four tasting points represented by ovals containing text descriptions. For example, the tasting point for initial taste is “flowering fruit” and is in the upper half of the Y-axis, denoting an intense flavor.

### EXAMPLE 5

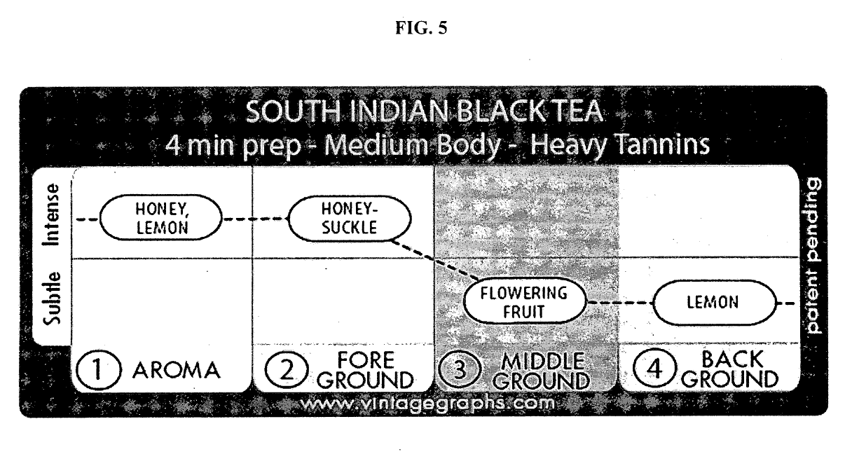

FIG. 5 is an exemplary label comprising a graph, for tea. In FIG. 5, the Y-axis includes two intensity descriptors (subtle and intense) while the X-axis includes aroma and three palate locations that are pertinent to tea (fore ground, middle ground, and back ground). There are four tasting points represented by ovals containing text descriptions. For example, the tasting point for aroma is “honey, lemon” and is in the upper half of the Y-axis, denoting an intense aroma.

### EXAMPLE 6

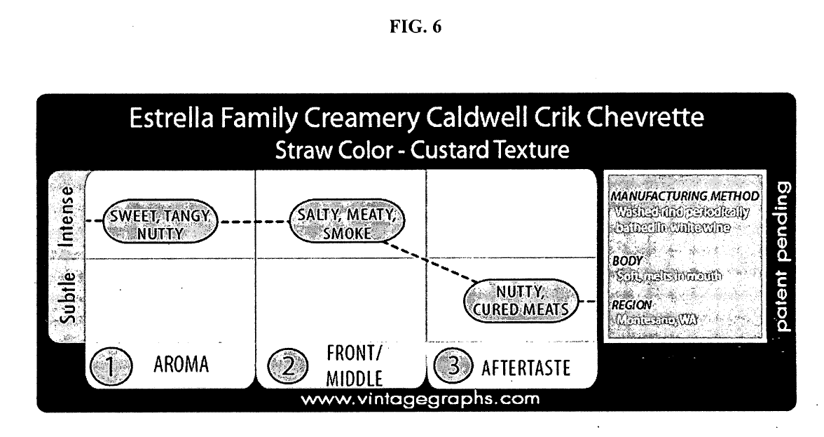

FIG. 6 is an exemplary label comprising a graph, for cheese. In FIG. 6, the Y-axis includes two intensity descriptors (subtle and intense) while the X-axis includes aroma and two palate locations (front/middle and aftertaste). Here, front/middle can be associated with the experience when a person presses the cheese against the roof of the mouth and moves the cheese around. The aftertaste is about at the time of, or after, swallowing the cheese. There are three tasting points represented by ovals containing text descriptions. For example, the tasting point for aftertaste is “nutty, cured meats” and is in the lower half of the Y-axis, denoting a subtle flavor intensity associated with this particular aftertaste description. Supplemental information is included in this label.

### EXAMPLE 7

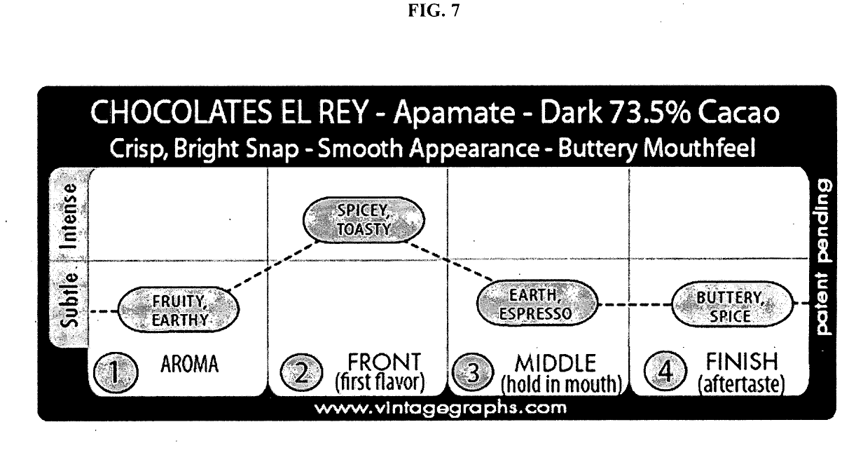

FIG. 7 is an exemplary label comprising a graph, for chocolate. In FIG. 7, the Y-axis includes two intensity descriptors (subtle and intense) while the X-axis includes aroma and three palate locations (front, middle, and finish). Here, front is the first flavor experienced at the point of taking some of the chocolate into the mouth. Middle can be associated with the experience when a person presses the chocolate against the roof of the mouth and moves the chocolate around. The finish is about at the time of, or after, swallowing the chocolate. There are three tasting points represented by ovals containing text descriptions. For example, the tasting point for front is “spicy, toasty” and is in the upper half of the Y-axis, denoting an intense first flavor.

### EXAMPLE 8

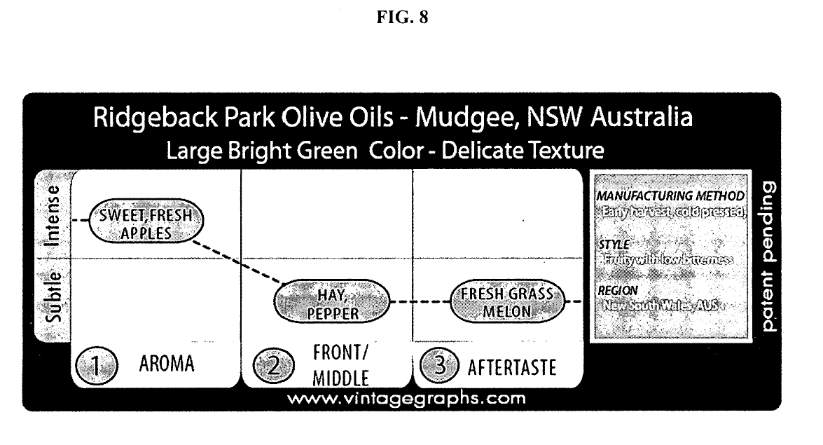

FIG. 8 is an exemplary label comprising a graph, for olive oil. In FIG. 8, the Y-axis includes two intensity descriptors (subtle and intense) while the X-axis includes aroma and two palate locations (front/middle and aftertaste). There are three tasting points represented by ovals containing text descriptions. For example, the tasting point for aftertaste is “fresh grass melon” and is in the lower half of the Y-axis, denoting a subtle aftertaste intensity. Supplemental information in this label includes the name, color, texture, manufacturing method, style, and region associated with the oil.

### EXAMPLE 9

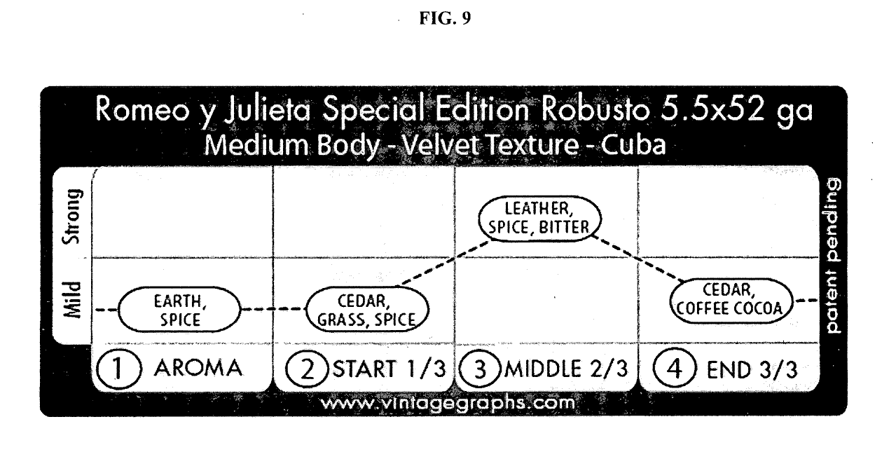

FIG. 9 is an exemplary label comprising a graph, for cigars. In FIG. 9, the Y-axis includes two intensity descriptors (mild and strong) while the X-axis includes aroma and three palate locations, which for cigars can be tied to the start, middle, and end of the cigar, in approximately thirds. There are four tasting points represented by ovals containing text descriptions. For example, the tasting point for “start ⅓” is “cedar, grass, spice” and is in the lower half of the Y-axis, denoting a mild flavor.

All patents, patent applications, and publications recited in this patent application are hereby incorporated by reference herein in their entireties.

Although illustrative embodiments and examples, and various modifications thereof, have been described in detail herein, one skilled in the art will appreciate that the present application need not be limited to these precise embodiments and the described modifications, and that various changes and further modifications may be practiced without departing from the scope or spirit of the invention as defined in the appended claims.

Other embodiments will be apparent to those of ordinary skill in the art, including embodiments that do not provide all of the features and advantages set forth herein. These other embodiments are also within the scope of this invention as claimed.

What is claimed is:

1. A method of characterizing a food, said method comprising:
(a) identifying a plurality of food characteristics each including a taste descriptor, an intensity descriptor, and a palate location;
(b) forming a label that includes each of said plurality of food characteristics; and
(c) associating said label to said food.

2. The method of claim 1, wherein said plurality of food characteristics is three or more characteristics each including a taste descriptor, an intensity descriptor, and a palate location.

3. The method of claim 1, said method further comprising identifying one or more smell factors each including an aroma descriptor and an intensity level.

4. The method of claim 1, wherein said label includes a graph that is suitable for illustrating said taste descriptor, said intensity descriptor, and said palate location for at least some of said characteristics identified in step (a).

5. The method of claim 4, wherein said graph is suitable for illustrating said taste descriptor, said intensity descriptor, and said palate location for each of said characteristics identified in step (a).

6. The method of claim 4, wherein said label further includes supplemental information that is not substantially included in said graph.

7. The method of claim 1, wherein said label includes only textual information.

8. The method of claim 1, wherein said label is a physical label that is directly coupled to a container comprising said food.

9. The method of claim 1, wherein said label is a physical label that is not directly coupled to a container comprising said food.

10. The method of claim 1, wherein said label is constructed from digital information, and wherein said label is communicated over a network.

11. The method of claim 1, wherein said food is selected from the group consisting of wine, beer, coffee, tea, chocolate, cheese, and tobacco.

12. The method of claim 11, wherein said food is wine.

13. A method of characterizing wine, said method comprising:
(a) identifying three or more wine characteristics each including a taste descriptor, an intensity descriptor, and a palate location;
(b) forming a label that includes each of said wine characteristics; and
(c) associating said label to said wine.

14. The method of claim 13, said method further comprising identifying a smell factor including an aroma descriptor and an intensity level.

15. The method of claim 13, wherein said label includes a graph that is suitable for illustrating said taste descriptor, said intensity descriptor, and said palate location for each of said wine characteristics identified in step (a).

16. The method of claim 15, wherein said label further includes supplemental wine information that is not substantially included in said graph, and wherein said label is directly coupled to a bottle of said wine by adhesion and/or the use of a bottle neck tag.

17. A label for characterizing a food, said label comprising means for displaying a plurality of food characteristics each including a taste descriptor, an intensity descriptor, and a palate location.

18. The label of claim 17, wherein said label further comprises means for displaying one or more smell factors each including an aroma descriptor and an intensity level.

19. The label of claim 17, wherein said food is wine.

20. The label of claim 19,
wherein said label includes a graph that is suitable for illustrating said taste descriptor, said intensity descriptor, and said palate location for each of said characteristics;
wherein said graph includes a first axis for displaying said intensity descriptor and a second axis for displaying said palate location;
wherein said label further includes supplemental wine information that is not substantially included in said graph; and
wherein said label is coupled to a bottle of said wine by adhesion and/or the use of a bottle neck tag.
